(19) United States
(12) Patent Application Publication
(10) Pub. No.: US 2010/0085636 A1
(43) Pub. Date: Apr. 8, 2010

(54) Optical System for a Confocal Microscope

(75) Inventor: Markus Berner, Bulach (CH)

Correspondence Address: MAGINOT, MOORE & BECK, LLP;CHASE TOWER, 111 MONUMENT CIRCLE, SUITE 3250, INDIANAPOLIS, IN, 46204, US

(73) Assignee: MHT OPTIC RESEARCH AG, Niederhasli (CH)

(21) Appl. No.: 12/573,225

(22) Filed: Oct. 5, 2009

(30) Foreign Application Priority Data
Oct. 6, 2008 (CH) 01580/08

(51) Int. Cl. G02B 21/06

(52) U.S. Cl. 359/385

(57) ABSTRACT

An optical system for a confocal microscope comprising: an illumination pattern (1) irradiating an object (6) with light rays reflected thereby, a beam splitter (2) for passing the light rays from the illumination pattern (1) in the direction of the object (6) and for deflecting the light rays reflected by the object (6) in a focal plane (7) in the direction of a detector (3) for detecting an image of the object (6), and a (4, 5, 8) between the beam splitter (2) and the object (6), at least one lens of the lens assembly (4, 5, 8) being arranged movable for shifting the focal plane (7) at the object (6), is configured such that at least one lens of the lens assembly (4, 5, 8) is an aspherical lens and the movable lens (4) of the lens assembly (4, 5, 8) is located distal from the object (6).

### REFERENCE TO PRIORITY APPLICATION

The present application claims priority to co-pending Swiss application No. 01580/08, filed on Oct. 6, 2008, in the name of the present inventor.

### BACKGROUND

The invention relates to an optical system for a confocal microscope.

Various types of 3D scanners exist which capture a surface of an object being scanned due to the fact that the surface is located focussed. Examples of such systems are laser confocal microscopes as are known from US2007/0109559 A1, or pOFPT as is described in the CH patent application 016247/07.

Known furthermore in prior art are optical systems as briefly discussed in the following.

DE 10 2005 013 949 A1 relates to a scanner for spot focussing a pencil beam, namely a parallel beam. In this scanner—not intended for use on a confocal microscope, and thus not required to satisfy exceptionally high demands on the imaging optics—an optical element located most distal from the object being scanned is shifted for focussing.

US 2002/0167723 A1 relates to a confocal microscope for scanning objects having a very small height, for example 0.1 mm, in the scanning direction, this being the reason why there is no problem as regards the optics with this confocal microscope. Problems regarding the optics materialize, however, when objects having a height of, for example, 10 mm need to be scanned, as explained further on.

EP 1 746 448 A2 relates to a microscope objective, the microscope concerned not being a confocal microscope and thus the demands on its optics are not so high. With a positioner serving to compensate the effects of changing temperatures a focus is varied over just a very small range.

WO 2008/10 1605 A1 relates to a confocal laser microscope in which positioning a lens corrects the color aberration of the optics. Adjusting the 3D scan is done elsewhere, there being an indication in the description that 3D shifting the object is possible.

WO 2005/09 1046 A1 relates to an intraoral scanner featuring a movable lens proximal to the object.

It is understood that “object” as referred to above and hereinafter has the meaning of an object to be scanned and imaged.

To implement 3D scanning the focus must pass through the object. Depending on the application concerned this can be done by moving the object, or by shifting the complete device or its optical system relative to the object, or by shifting at least one element in the optical system.

To scan objects having a height of 10 mm, for example, the scanning depth may greatly exceed the 3D resolution of the optical system, resulting in the optics of the optical system needing to satisfy higher demands than, for example, the scanner as recited in the aforementioned document US 2002/0167723 A1 which only needs to be designed to scan objects of very low height.

Common to all of these systems is that very high demands are made on the imaging quality. To precisely 3D capture the object, the size of a spot must be very small. Ideally the optics should have limited diffraction, i.e., furnish the theoretically possible accuracy. But, in some practical applications spot sizes of approx. 5 μm (RMS spot radius) need to be satisfied which still makes for an exceedingly high demand.

In some systems (e.g., parallel confocal microscope or pOFPT) the whole surface is scanned simultaneously, thus requiring the imaging quality to be very good over the whole surface, adding again to the demands on the device.

On top of this, the numerical aperture NA of such devices must need to be relatively large at the object end to obtain a good 3D resolution. This too, adds to the demands on the optical system.

This is why whenever possible the optical system is not varied and either the object or the whole device or its optical system is moved relative to the object during scanning. It is already very difficult to produce an optical system having the accuracy as required at a focal plane, but it is even more difficult to achieve the wanted imaging quality in all focal positions when lenses are moved in the optical system.

Should, nevertheless, an element need to be shifted in the optics the typical approach is to use an infinitely corrected optics by shifting the lens most proximal to the object as is already known from the aforementioned document WO 2005/09 1046 A1 to thus tweak the focus with no major problem whilst imaging quality (distortions, magnification, crisp imaging) remains roughly the same in all focal planes.

One such optical system is shown in FIG. 1 by way of an example of the prior art. This optical system comprises an illumination pattern 1, a beam splitter 2, a detector 3 and a first lens 4 at the illumination pattern 1 end and a second lens 5 at the object 6 end. Rays of light from the illumination pattern 1 pass through the beam splitter 2 in the direction of the object 6 through the first lens 4 and the second lens 5 to a focal plane 7 on the object 6. The light rays reflected back from the object 6 pass through the lenses 5, 4 and are deflected at the beam splitter 2 in the direction of the detector 3 where an image of the object 6 is detected.

Where a laser confocal microscope is concerned the illumination pattern 1 consists of at least one source of a light spot, the laser and where a pOFPT device is concerned the illumination pattern 1 consists of an image which is beamed through by a source of light.

The arrow above the second lens 5 indicates movement of the second lens 5 resulting in a corresponding movement of the focal plane 7 at the object 6 as indicated by a dashed arrow. The various positions of the second lens 5 and the corresponding positions of the focal plane 7 are indicated in FIG. 1 by the reference numerals 5a and 7a, 5b and 7b and 5c and 7c. To produce the movement of the second lens 5 a drive is provided which, for example, may be a controlled motor.

However, in some applications this approach has a serious drawback. For example, where a dental intraoral scanner is concerned, the optics inserted into the mouth of the patient need to be highly compact. But when the second lens at the object end is configured such that it is provided movable for shifting the focal plane, the scanner at the object end, and thus in the mouth of the patient must be configured larger to accommodate the movement of the lens and its drive, resulting in such a scanner just at the end where it is needed as compact as possible being larger in size. Achieving a more compact configuration with a movable lens at the object end is only possible with great difficulty and is correspondingly expensive.

### SUMMARY

It is thus one object of the present invention to provide an optical system for a confocal microscope which, especially at the object end being scanned and imaged, is configured compact.

This object is achieved in accordance with one embodiment of the invention in which an optical system for confocal microscope is particularly configured such that at least one lens of the lens assembly is an aspherical lens and the movable lens of the lens assembly is located distal from the object. This now makes it possible to achieve a compact configuration of the optical system proximal to the object.

Preferably an aspherical lens is employed as the movable lens of the lens assembly.

The lens assembly comprises preferably the movable lens and at least one non-movable lens located proximal to the object. Additionally the lens assembly comprises beam guidance means with non-movable lenses.

More specifically a configuration of the lenses is computed by means of a optimization program for optical lenses such that a spot size for all spots in an image is minimized for all focal planes, it being sufficient when this is done for eleven spots in the image and at three different focal planes. The optimization program for optical lenses to obtain a minimum spot size preferably undertakes imaging of the object on a curved surface for each focal plane as an aspherical surface.

One of the non-movable lenses in the optical system is preferably a lens of highly refractive material and configured very thick, the glass of the thick lens preferably being highly refractive material with a refractive index exceeding 1.7 and more than 25 mm thick so that the actual geometrical length of the optics is more than 12.5 mm longer than the optical length of the optics.

Preferably the scanning depth is at least 100 times the 3D resolution, a factor of 200 between 3D resolution and scanning range materializing, for example, with a relatively high 3D resolution of approximately 50 μm for a height of approximately 10 mm to be scanned.

Correcting distortion of scanned surfaces of the object can be done by compensation computations, possibly as computed by an optimization program or by calibration measurement.

The optical system in accordance with the invention is particularly suitable for use in intraoral dental scanning. The intraoral scanner comprises more specifically a proximal portion for insertion into the mouth of a patient and a distal portion remote from the mouth of the patient, the proximal portion being configured slim and compact and the movable lens being arranged in the distal portion.

### DESCRIPTION OF THE FIGURES

These and further features and details of the invention will become clearer to the person skilled in the art from the following detailed description with reference to the attached drawings showing features of the present invention by way of example in which:

FIG. 1 is a view of an optics for a confocal microscope as proposed in prior art,

FIG. 2 is a view of an optics for a confocal microscope as proposed in accordance with the present invention,

FIG. 3 is a view of the compensation principle used in the present invention.

### DESCRIPTION OF THE INVENTION

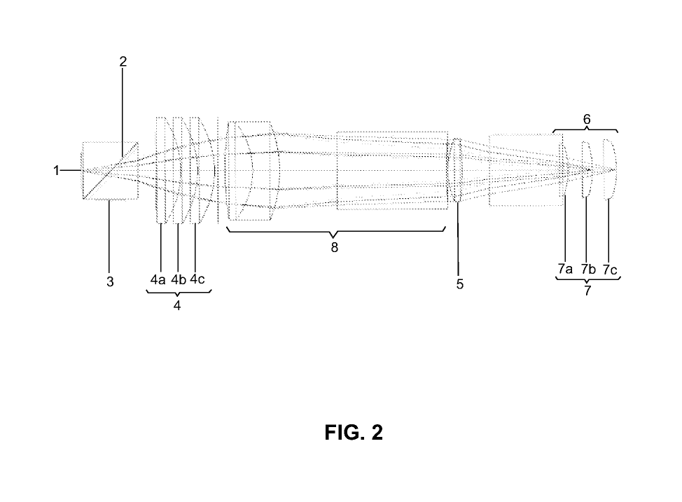

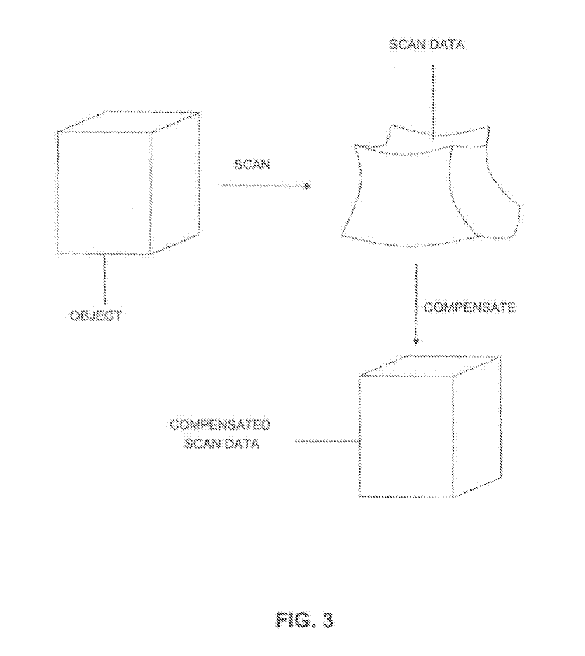

The present invention will now be explained in detail by way of a preferred embodiment with reference to FIGS. 2 and 3.

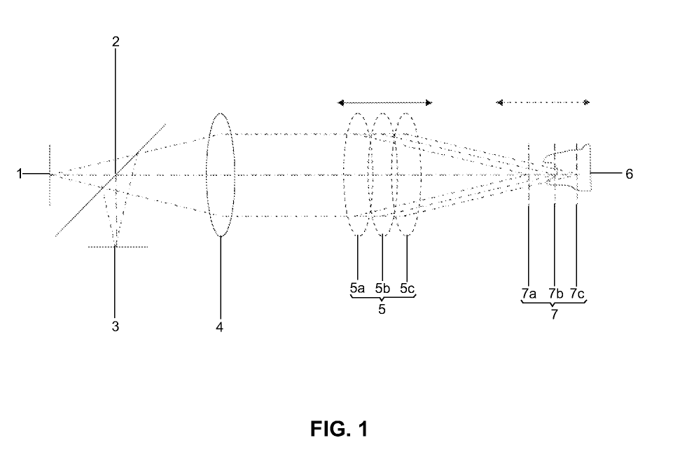

Referring now to FIG. 2 there is illustrated the basic configuration of an optical system for a confocal microscope in accordance with the present invention. Like the optical system as shown in FIG. 1 for a prior art confocal microscope the optical system for a confocal microscope in accordance with the present invention as shown in FIG. 2 consists of an illumination pattern 1, a beam splitter 2, a detector 3, a first lens 4 at the illumination pattern 1 end and a second lens 5 at the object 6 end. In addition to the optical system as shown in FIG. 1 the optical system as shown in FIG. 2 comprises furthermore beam guidance means 8 with non-movable lens between the first lens 4 and the second lens 5. The beam guidance means 8 now make it possible to configure the optical system long and slim despite the larger numerical aperture NA at the object end. This is particularly because one of the lenses used is very thick and the glass is formulated with a very high refractive index. To achieve the necessary imaging quality preferably at least one of the optical systems is likewise configured aspherical. Thus in the optical system as shown in FIG. 2 the rays pass from the illumination pattern 1 through the beam splitter 2 in the direction of the object 6 through the first lens 4, the beam guidance means 8 and the second lens 5 up to a focal plane 7 at the object 6. Unlike the optical system as shown in FIG. 1 in the optical system as shown in FIG. 2 the first lens 4 distal from the object is moved through three different positions of the first lens 4, each identified 4a, 4b and 4c. In accordance with the movement of the first lens 4 the focal plane 7 at the object 6 is shifted to positions identified 7a, 7b and 7c. For moving the first lens 4 a drive (not shown) is used which may be a controlled motor, for example.

The light rays reflected at each focal plane 7a, 7b and 7c pass through the lens assembly 4, 5, 8 and are deflected at the beam splitter 2 in the direction of the second lens 5 where the image of the object 6 is detected in the focal plane 7.

To attain the necessary imaging quality in all focal planes 7a, 7b and 7c especially the following precautions are taken:

Aspherical lenses are given preference which recently have become much less costly and with much better precision to produce than hitherto for since they can now even be pressed, resulting in such lenses in mass production being no more expensive substantially than the classic spherical lenses.

Computing the lenses is done with an optimization program for optical lenses. With this optimization program especially the size for all spots in the image is minimized for all focal planes. In implementing optimization it has been discovered that it is sufficient to minimize the spot size at eleven different spots in the image and at three different focal planes.

With the optimization program the illumination pattern 1 is furthermore imaged on a curved surface, the shape of which may be freely optimized by the optimization program to obtain small spot sizes where possible. The focal plane is thus not actually a plane but an optionally curved surface, an aspherical surface likewise being selected for the focal plane.

For each position of the focal plane 7a, 7b, 7c a separate aspherical surface is optimized to attain minimized spot sizes for each position.

A total of three aspherical surfaces now make it possible to achieve spot sizes minimized at all positions in the image and at all positions of the focal plane for a large numerical aperture NA defined by the aperture angle and refractive index of a lens.

To render the optical system sufficiently long so that even the rearmost teeth are reached when used as an intraoral scanner a non-movable lens 5, 8 of the lens assembly 4, 5, 8 is made of highly refractive material and configured very thick. Preferably the refractive index of the glass of the thick lens 5, 8 made of highly refractive material exceeds 1.7, such as 1.92, for example, and its thickness exceeds 25 mm, such as 31.5 mm, for example. An aperture angle is preferably selected larger than 20°, the actual geometrical length of the optics then being 12.5 mm longer than the optical length of the optics because of the law of refraction. With example values of 1.92 for the refractive index and 31.5 mm for the thickness of a non-movable lens 5, 8 an optical length by the law of refraction is then 31.5 mm/1.92=14.4 mm. But an actual geometrical length of the optics amounts to 31.5 mm. The optics can thus now be made longer by approximately 15 mm which is sufficient for scanning even the rearmost teeth in the mouth of the patient. Without this special configuration the optical system would have been either shorter, thicker or less accurate or would have no longer permitted such a large numerical aperture.

The optical system of the present invention now makes it possible to scan body surfaces with high accuracy by the optics being designed to advantage.

The drawback in this arrangement is that the scanned surfaces appear distorted. Flat surfaces appear curved, straight lines appear unstraight. Apart from this, the magnifications and curvatures at each position in the image differ.

However, modern computers now make it possible without any complication to compensate such distortions since they are totally reproducible.

The theoretical distortions are known, since the shape of the image surface was, of course, computed by the optimization program, the result of which can be made use of to compensate the distortions. It is more specifically preferred, however, to also scan the distortion and to then compensate it. Such distortion compensation is illustrated, for example, in FIG. 3.

When compensating by scanning the distortion it is good practice to proceed as follows:

First the flat surfaces are scanned which appear curved after scanning.

Then the curvature at each position of an object is scanned. In subsequent scanning each value is then retrocorrected by this curvature. The curvatures can be mapped and approximated by a mathematical function such as e. g., a polynomial.

After this, plates having straight lines are scanned, the results of which are firstly corrected to eliminate the curvature (see above) before then determining the shape of the lines which are then corrected the same as the surface curvatures (mapped or function approximated).

The present invention features an optical system for a confocal microscope in which a focal plane is shifted by moving a lens. In accordance with the invention the movable lens is especially located as far distal as possible to thus achieve a compact proximal configuration of the optical system. More specifically, the optical system can be put to use for intraoral dental scanning without any increase in the dimensions of the scanner in the mouth of a patient.

1. An optical system for a confocal microscope comprising an illumination pattern (1) irradiating an object (6) with light rays reflected thereby, a beam splitter (2) for passing the light rays from the illumination pattern (1) in the direction of the object (6) and for deflecting the light rays reflected by the object (6) in a focal plane (7) in the direction of a detector (3) for detecting an image of the object (6), and a lens assembly (4, 5, 8) between the beam splitter (2) and the object (6), at least one lens of the lens assembly (4, 5, 8) being arranged movable for shifting the focal plane (7) at the object (6), characterized in that
at least one lens of the lens assembly (4, 5, 8) is an aspherical lens and
the movable lens (4) of the lens assembly (4, 5, 8) is located distal from the object (6).

2. The optical system as set forth in claim 1, characterized in that an aspherical lens is employed as the movable lens (4) of the lens assembly (4, 5, 8).

3. The optical system as set forth in claim 2, characterized in that the lens assembly (4, 5, 8) includes the movable lens (4) and at least one non-movable lens (5, 8) located proximal to the object (6).

4. The optical system as set forth in claim 1, characterized in that the lens assembly (4, 5, 8) includes the movable lens (4) and at least one non-movable lens (5, 8) located proximal to the object (6).

5. The optical system as set forth in claim 4, characterized in that the lens assembly (4, 5, 8) further includes beam guidance means (8) with non-movable lenses.

6. The optical system as set forth in claim 1, characterized in that one aspect of the lens assembly (4, 5, 8) is computed by means of an optimization program for optical lenses such that the size of all spots in an image is minimized for a plurality of focal planes (7a, 7b, 7c).

7. The optical system as set forth in claim 6, characterized in that minimizing the spot size is performed for eleven spots in the image and at three different focal planes (7a, 7b, 7c).

8. The optical system as set forth in claim 6, characterized in that the optimization program for optical lenses to obtain a minimum spot size involves imaging the object (6) on a curved surface for each focal plane (7a, 7b, 7c) as an aspherical surface.

9. The optical system as set forth in claim 1, characterized in that at least one of the non-movable lenses (5, 8) of the lens assembly (4, 5, 8) is configured as a lens made of highly refractive material and very thick.

10. The optical system as set forth in claim 9, characterized in that the glass of the thick lens (5, 8) is highly refractive material with a refractive index exceeding 1.7 and more than 25 mm thick so that the actual geometrical length of the optics is more than 12.5 mm longer than the optical length of the optics.

11. The optical system as set forth in claim 1, characterized in that the scanning depth exceeds 100 times the 3D resolution.

12. The optical system as set forth in claim 6, characterized in that the optimization program is further operable to correct distorted images of scanned surfaces of the object (6) by performing compensation computations.

13. The optical system as set forth in claim 9, further comprising an optimization program operable to correct distorted images of scanned surfaces of the object (6) by performing compensation computations.

14. The optical system as set forth in claim 12, characterized in that computing the compensation is done on the basis of computing optimization program or by calibration measurement.

15. The optical system as set forth in claim 1, characterized in that the system is employed within an intraoral dental scanner.

16. The optical system as set forth in claim 15, characterized in that the intraoral scanner comprises a proximal portion for insertion into the mouth of a patient and a distal portion away from the mouth of the patient, the proximal portion being configured slim and compact and the movable lens (4) being arranged in the distal portion.
